(19) United States
(12) Patent Application Publication
(10) Pub. No.: US 2011/0078959 A1
(43) Pub. Date: Apr. 7, 2011

(54) Opening trim weather strip

(75) Inventor: Masahiro Nozaki, Kiyosu-shi (JP)

(73) Assignee: TOYODA GOSEI CO., LTD., Kiyosu-shi (JP)

(21) Appl. No.: 12/923,486

(22) Filed: Sep. 23, 2010

(30) Foreign Application Priority Data
Sep. 25, 2009 (JP) PATENT2009-220233
Dec. 24, 2009 (JP) PATENT2009-292617
Dec. 24, 2009 (JP) PATENT2009-292618

(51) Int. Cl. E06B 7/16

(52) U.S. Cl. 49/489.1

(57) ABSTRACT

An opening trim weather strip that is readily attached to a flange, and contributes to reduction in weight of a vehicle body. The opening trim weather strip has a trim portion and a seal portion integrally formed with the trim portion, and includes an upper side part, vertical side parts and a lower side part for attachment to an upper side, vertical sides and a lower side of a door opening portion, respectively, so as to have a loop-like configuration. The opening trim weather strip includes a first section in which the lower side part or the vertical side part along with the lower side part is partly covered with an inner cover, and a second section uncovered with the inner cover, and the trim portion in the first section is entirely composed of a rubber-like elastic body, whereas the trim portion in the second section is composed of a rubber-like elastic body in which an insert member is embedded.

### CROSS-REFERENCE TO RELATED APPLICATION

This application is related to and claims priority from Japanese patent applications No. 2009-220233, 2009-292617 and 2009-292618 incorporated herein by reference.

### BACKGROUND OF THE INVENTION

1. Field of the Invention

The present invention relates to an opening trim weather strip (hereinafter will be referred to OTWS) for providing a seal between a door of a motor vehicle and a door opening portion of a vehicle body.

2. Description of Related Art

In order to provide a seal between a vehicle door and a door opening portion of a vehicle body, conventionally, a door weather strip is provided along an outer periphery of a door frame, a glass run is attached to a channel along an inner periphery of the door frame, etc., and an OTWS is attached to a flange provided in the door opening portion.

As shown in FIG. 1, an OTWS 10 is attached to a door opening portion 12 over an entire length thereof, and when a vehicle door is closed, the OTWS 10 contacts a door frame 14 and/or an outer periphery of a door panel to seal between the door opening portion 12 and the vehicle door. As shown in FIG. 2, a flange 16 is formed in the door opening portion 12 by bonding an inner panel 18 and an outer panel 20 to each other through welding.

The OTWS 10 is attached to the flange 16 in a trim portion 22 with a generally U-shaped cross-section. An insert member 24 such as a metal insert, etc. is embedded in the trim portion 22 for increasing its holding force against the flange 16, and an outer side wall 26, an inner side wall 28 and a bottom wall 30 define a generally U-shaped cross-section (see Publication of Japanese patent No. 3893675, for example).

A tubular seal portion 32 is provided in the outer side wall 26 of the trim portion 22 to contact a protruding part (not shown) of the door frame 14 and the outer periphery of the door panel, thereby sealing the same. A cover lip 34 projects inwardly from the bottom wall 30 to cover an end of an interior member 36 such as a garnish, a ceiling member or other members mounted on a vehicle compartment, thereby covering a gap between the OTWS 10 and the interior member 36, and improving an appearance therearound.

As shown in FIG. 2, in order to hold the flange 16, outer holding lips 38 and an inner holding lip 40 are provided in the outer side wall 26 and the inner side wall 28 of the trim portion 22. When the flange 16 is inserted into the trim portion 22, tip ends of the outer holding lips 38 and the inner holding lip 40 flex to contact side faces of the flange 16 closely, thereby holding the flange 16. As a result, the OTWS 10 can be attached to the flange 16.

As shown in FIG. 3, the OTWS 10 is formed by extrusion into a single body. Then, the extruded body is connected via a joint 42 annularly. Consequently, the OTWS 10 has a loop-like configuration and includes an upper side part 44, a vertical side part 46 and a lower side part 48, which are respectively attached to an upper side, a vertical side and a lower side of the door opening portion 12.

As shown in FIG. 1 and FIG. 4, an inner cover 50 is attached to the lower side part 48 of the OTWS 10 to protect the same and cover the trim portion 22. The inner cover 50 is attached by fitting a leg 52 thereof with a clip 54 mounted on the flange 16. A cover part 56 of the inner cover 50 covers the trim portion 22 and a main part 58 covers the door opening portion 12. As shown in FIG. 2, another inner cover 51 may be attached so as to face a center pillar.

The clip 54 is mounted on the flange 16 so that the wall thickness thereof increases, and an insert member 24 is embedded in the trim portion 22. Therefore, a force required for attaching the trim portion 22 to the flange 16 is enlarged to lower the work efficiency in attaching the trim portion 22. And the weight of the trim portion 22 is increased due to the embedding of the insert member 24, thereby blocking the reduction in weight of a vehicle body. In addition, as shown in FIG. 4, where a cover lip 62 obstructs the inner cover 50, the cover lip 62 is removed from the trim portion 22 as indicated with dotted lines in FIG. 4, which is very troublesome.

In order to overcome this problem in another example shown in FIG. 5, a clip 64 is attached to a tip end of the inner panel 18. By fitting a projection provided in a leg 66 of an inner cover 68 in a hole 70 provided in an extended part 72 of the clip 64, the inner cover 68 is mounted. In addition, no insert member is embedded in a trim portion 74 of an OTWS 76, which is covered with the inner cover 68 (see Publications of Japanese unexamined patent applications Nos. Hei 8-188092 and Hei 5-270326, for example). In this case, the trim portion 74 of the OTWS 76 can be attached to the flange 16 on which the clip 64 is not mounted, but additional works are needed for mounting the clip 64 on another part, which is very troublesome. Where no insert member is embedded, and consequently, the holding force of the trim portion 74 against the flange 16 is decreased, the trim portion 74 is prevented from coming off the flange 16, because the inner cover 68 is fitted with the clip 64, thereby pressing the trim portion 74 against the flange 16.

In another example shown in FIG. 6, a clip securing section 80 is provided in the door opening portion 12. One end of a clip 82 is secured to the clip securing section 80, whereas the other end of the clip 82 defines a cover holding section 84 with a generally U-shaped cross-section. By fitting a leg 86 of an inner cover 88 in the cover holding section 84, the inner cover 88 is mounted (see Publication of Japanese unexamined patent application No. Hei 5-270326, for example.). In this case, in order to provide the clip securing section 80 in the door opening portion 12, the door opening portion 12 must be worked, and the securing of the clip 82 to the clip securing section 80 is troublesome.

The inner cover covers a trim portion in not only a relatively straight lower side part of the OTWS but also a corner part and a vertical side part thereof. At this time, the trim portion for attachment to the corner part is attached to a curving flange. Consequently, the trim portion also curves so that a sufficient force for holding the flange cannot be obtained.

### SUMMARY OF THE INVENTION

Accordingly, it is an object of the present invention to provide an OTWS that can be favorably mounted on a flange, can exhibit an excellent holding force against the flange even in corners of the door opening portion, and can serve to reduce the weight of a vehicle body.

In accordance with the present invention, an opening trim weather strip for a motor vehicle, which is attached to an opening portion of a motor vehicle for providing a seal between a door of the motor vehicle and the door opening portion, has a trim portion for attachment to a flange provided in the door opening portion, and a seal portion integrally formed with the trim portion for contacting the door to provide a seal between the door and the door opening portion. The trim portion includes an upper side part, a vertical side part, and a lower side part for attachment to an upper side, a vertical side and a lower side of the door opening portion, respectively, and is formed into a loop-like configuration. The door opening trim weather strip includes a first section in which one of the lower side part and the vertical side part along with the lower side part is partially covered with an inner cover, and a second section that is not covered with the inner cover. The trim portion in the first section and the trim portion in the second section are formed so as to have different cross-sectional constructions.

In accordance with the present invention, the trim portion in the first section of the OTWS is covered with the inner cover so that the trim portion can be protected when passengers get on and off the vehicle compartment. The first section is formed such that no insert member is embedded, or the cross-sectional area is small. Therefore, the weight of the first section can be reduced, thereby contributing to the lightening of a vehicle body. In addition, since the first section is covered with the inner cover, the trim portion is prevented from coming off the flange in the door opening portion. In contrast, the second section has the insert member in the trim portion thereof, thereby increasing a force for holding the flange.

The cross-sectional area of the trim portion in the first section can be decreased by forming side walls of the trim portion short, forming flange holding lips short, forming no decorative layer, and/or forming side walls of the trim portion to have a decreased wall thickness. With one or combinations of these arrangements, the weight of the trim portion of the first section can be reduced. In addition, by forming the trim portion of a sponge material, and/or providing no cover lip, the weight of the trim portion of the first section can be further reduced.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a perspective view of a motor vehicle in a state where a door is opened, which is seen from a rear side thereof;

FIG. 2 is a partially sectioned perspective view of a conventional opening trim weather strip in an attached state to an upper side of a door opening portion of a motor vehicle;

FIG. 3 is a front view of an opening trim weather strip;

FIG. 4 is a sectional view of a conventional opening trim weather strip in an attached state to a lower side of a door opening portion of a motor vehicle, taken along line B-B in FIG. 3;

FIG. 5 is a sectional view of another conventional opening trim weather strip in an attached state to a lower side of a door opening portion of a motor vehicle;

FIG. 6 is a sectional view of a still another conventional opening trim weather strip in an attached state to a lower side of a door opening portion of a motor vehicle;

FIG. 7 is a front view of a first embodiment of an opening trim weather strip in accordance with the present invention for attachment to a front door, which shows the position of the first section;

FIG. 8 is a front view of a first embodiment of an opening trim weather strip in accordance with the present invention for attachment to a rear door, which shows the position of the first section;

FIG. 9 is a sectional view of a first embodiment of an opening trim weather strip in the second section, taken along line A-A in FIG. 3;

FIG. 10 is a sectional view of a first embodiment of an opening trim weather strip in the first section, taken along line B-B in FIG. 3;

FIG. 11 is a perspective view of a joint area between the first section and the second section of a first embodiment of an opening trim weather strip;

FIG. 12 is a sectional view of a second embodiment of an opening trim weather strip in the first section;

FIG. 13 is a sectional view of a third embodiment of an opening trim weather strip in the first section;

FIG. 14 is a sectional view of a fourth embodiment of an opening trim weather strip in the first section;

FIG. 15 is a sectional view of a fifth embodiment of an opening trim weather strip in the first section;

FIG. 16 is a front view of a sixth embodiment of an opening trim weather strip in accordance with the present invention for attachment to a front door, which shows the position of the first section;

FIG. 17 is a front view of a sixth embodiment of an opening trim weather strip in accordance with the present invention for attachment to a rear door, which shows the position of the first section;

FIG. 18 is a sectional view of a sixth embodiment of an opening trim weather strip in the second section, taken along line C-C in FIG. 16;

FIG. 19 is a sectional view of a sixth embodiment of an opening trim weather strip in the first section, taken along line D-D in FIG. 16;

FIG. 20 is a sectional view of a sixth embodiment of an opening trim weather strip in a corner part of the first section, taken along line E-E in FIG. 16;

FIG. 21 is a front view of a seventh embodiment of an opening trim weather strip in accordance with the present invention for attachment to a front door;

FIG. 22 is a front view of a seventh embodiment of an opening trim weather strip in accordance with the present invention for attachment to a rear door;

FIG. 23 is a sectional view of a seventh embodiment of an opening trim weather strip in the second section, taken along line F-F in FIG. 21;

FIG. 24 is a sectional view of a seventh embodiment of an opening trim weather strip in the first section, taken along line G-G in FIG. 21;

FIG. 25 is a sectional view of an eighth embodiment of an opening trim weather strip in the first section;

FIG. 26 is a sectional view of a ninth embodiment of an opening trim weather strip in the first section; and

FIG. 27 is a sectional view of a tenth embodiment of an opening trim weather strip in the first section.

### DETAILED DESCRIPTION OF THE PREFERRED EMBODIMENTS

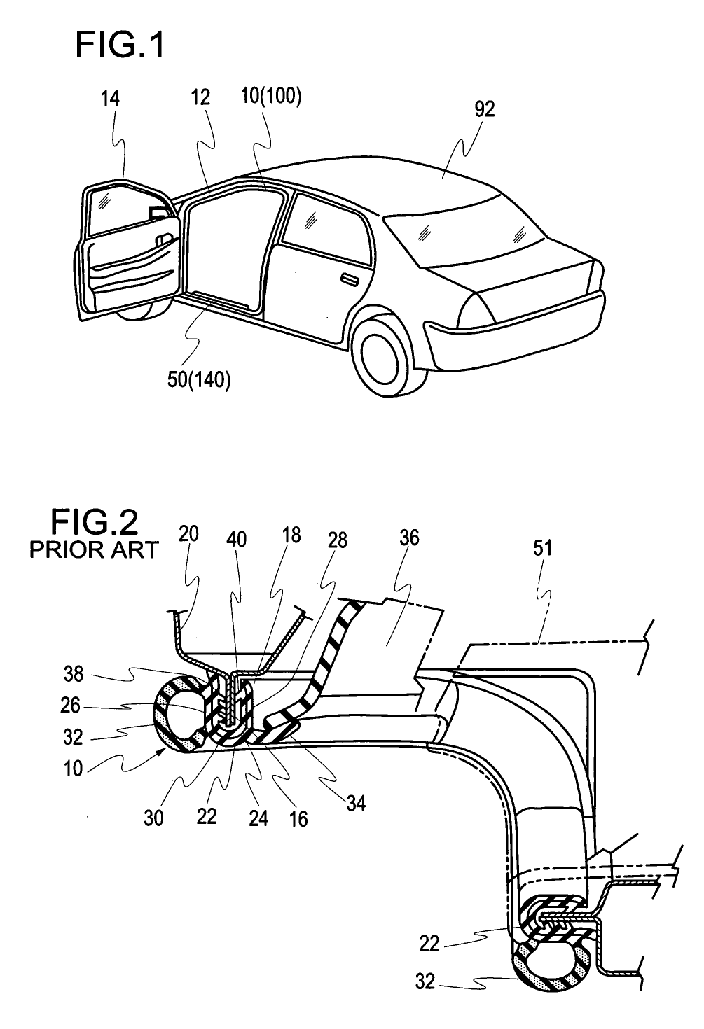

The present invention relates to an OTWS adapted to be attached to a door opening portion of a front door and/or a rear door of a motor vehicle, and hereinafter, a first embodiment of the present invention will be explained with reference to FIGS. 1, 3, 7 through 11.

As shown in FIG. 1, a body 92 of a motor vehicle has a door opening, and the door opening is closed and opened with a vehicle door. The door opening is defined with a door opening portion 12, and a flange 16 is provided along the door opening portion 12 by welding ends of an inner panel 18 and an outer panel 20 composing the body 92 together. An OTWP 100 is mounted on the flange 16 to provide a seal between the door opening portion 12 and the vehicle door.

The number of panels welded together for providing the flange 16 varies from two panels to eight panels according to the position in the door opening portion 12.

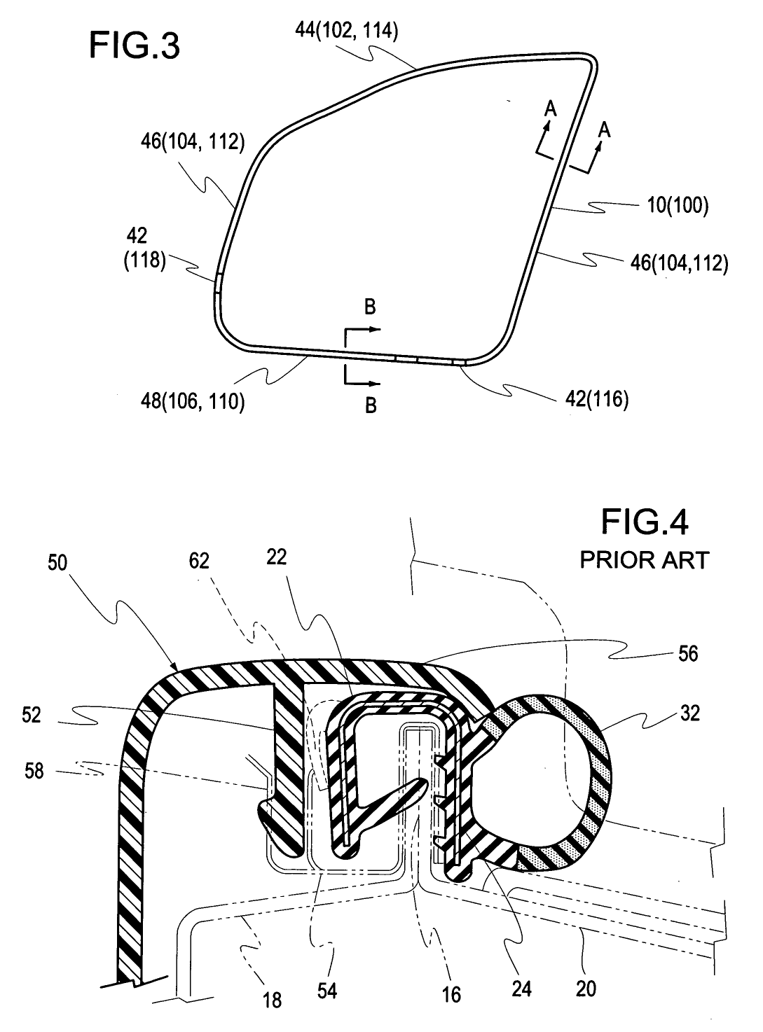

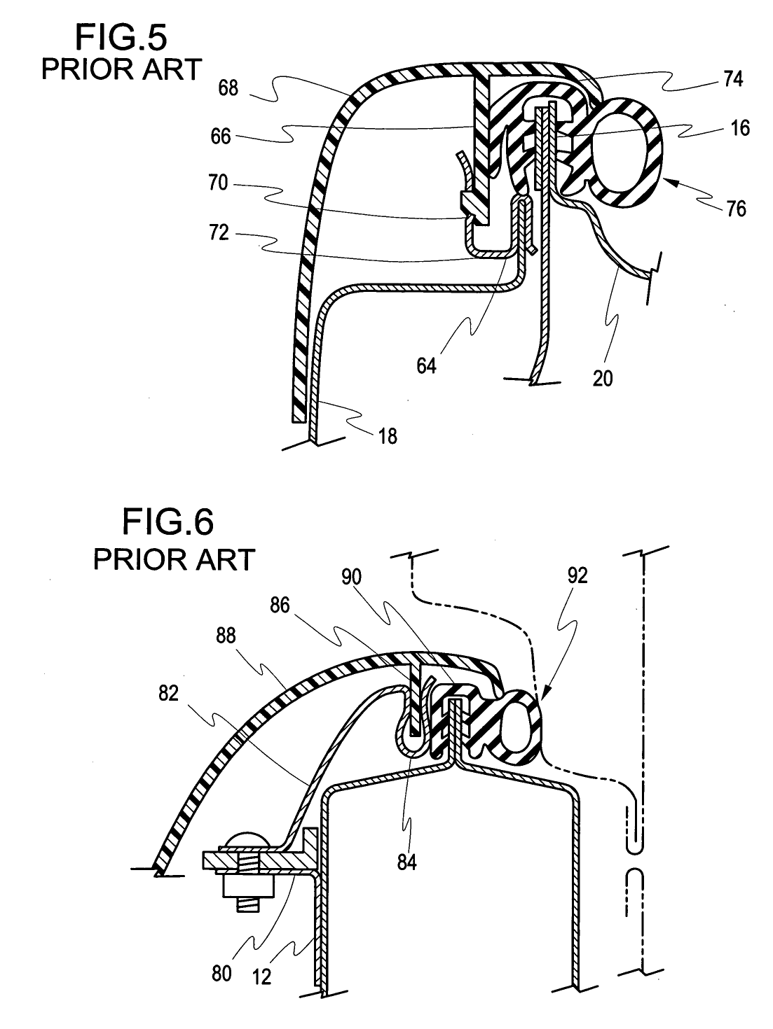

As shown in FIG. 3, the OTWS 100 includes an upper side part 102, vertical side parts 104 and a lower side part 106, which are adapted to be respectively attached to an upper side, vertical sides, a lower side of the door opening portion 12 along with corners thereof with a loop-like configuration. Consequently, the OTWS 100 can provide a secure seal over an entire circumference of the door opening portion 12.

And the OTWS 100 has a first section covered with a later describing inner cover 140 and a second section uncovered therewith.

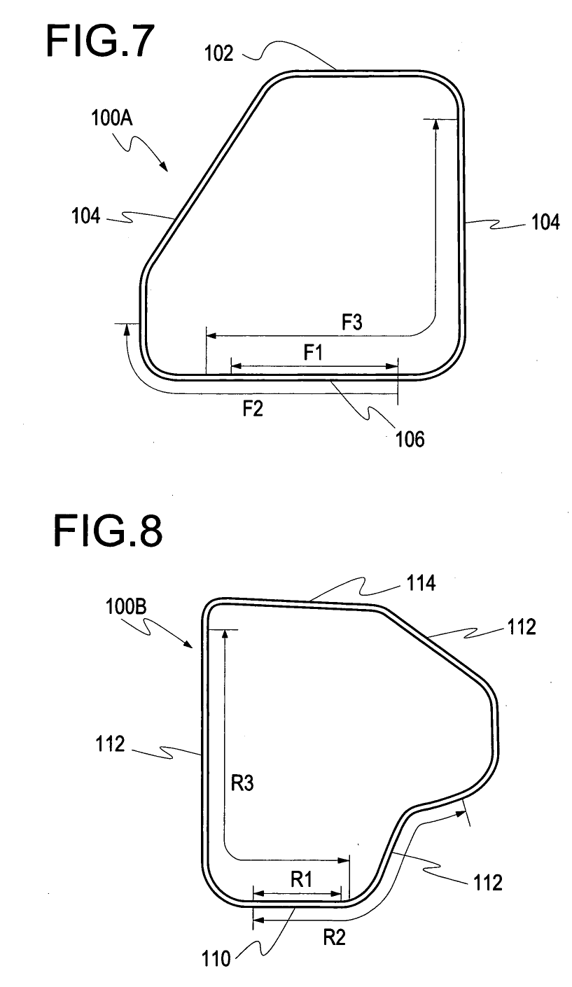

FIG. 7 shows areas of the first section of an OTWS 100A for attachment to a front door of a motor vehicle.

An area designated as F1 corresponds to the case where the first section is formed in only the lower side part 106, an area designated as F2 corresponds to the case where the first section is formed in the lower side part 106 and a lower part of a front vertical side part 104, and an area designated as F3 corresponds to the case where the first section is formed in the lower side part 106 and a rear vertical side part 104. In each of these cases, a remaining area of the OTWS 100A corresponds to the second section.

FIG. 8 shows areas of the first section of an OTWS 100B for attachment to a rear door of a motor vehicle.

An area designated as R1 corresponds to the case where the first section is formed in only a lower side part 110, an area designated as R2 corresponds to the case where the first section is formed in the lower side part 110 and a lower part of a rear vertical side part 112, and an area designated as R3 corresponds to the case where the first section is formed in the lower side part 110 and a front vertical side part 112. In each of these cases, a remaining area of the OTWS 100B corresponds to the second section, similarly to the case of the front door.

The present embodiment will be explained with reference to the cases where the first section is provided in the lower side part 106 or 110 (F1 or R1), but, in the cases where the first section is formed in different parts (F2, F3, R2 or R3), the OTWS is arranged similarly.

In the OTWSs 100A and 100B, the upper side parts 102 and 114 and vertical side parts 104 and 112, which correspond to the second section, are formed straight by extrusion, whereas the lower side parts 106 and 110, which correspond to the first section, are also formed by extrusion separately from the upper side parts 102 and 114 and vertical side parts 104 and 112. As shown in FIG. 3, two weather strips thus extruded straight are jointed into a loop-like configuration by molding in conformity with a configuration of the door opening portion 12, thereby define two joints 116 and 118.

The OTWSs 100A and 100B are respectively attached to the flange 16 sequentially from one end toward the other end thereof.

Where the first section includes the lower side part 106 or 110 and the vertical side part 104 or 112 (F2, F3, R2 or R3), areas corresponding to the first section and the second section are separately formed by extrusion, and are joined with two joints, similarly to the above-described case.

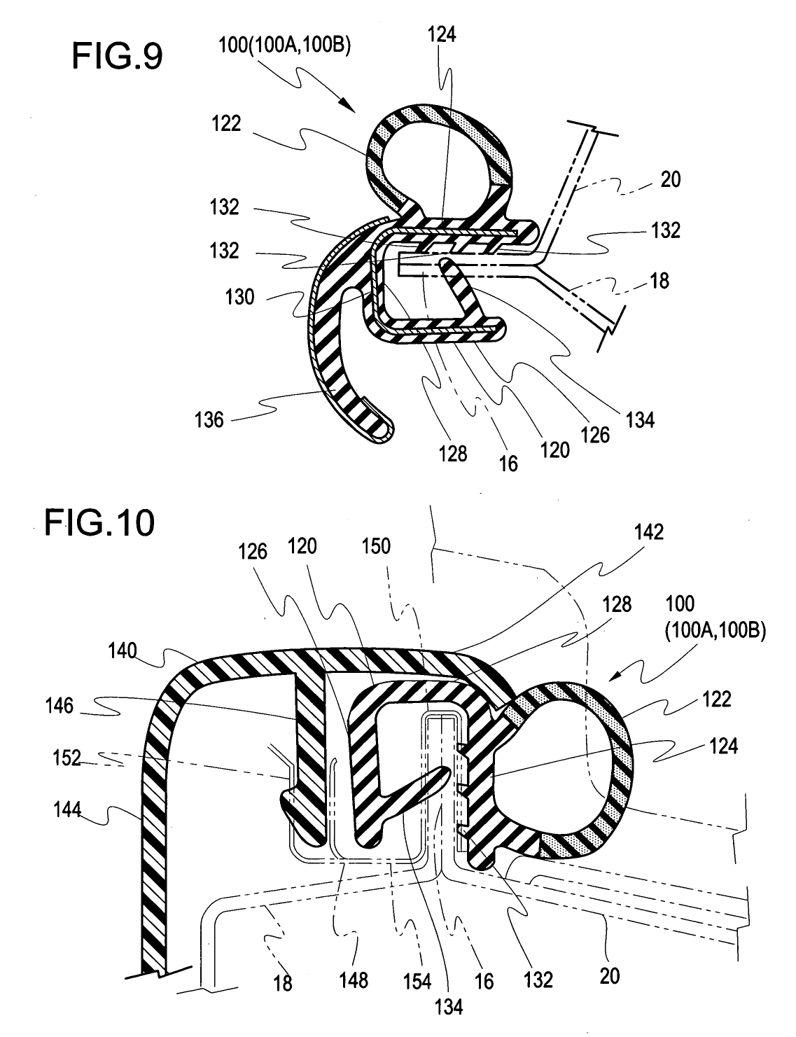

As shown in FIG. 9, the upper side parts 102 and 114 and the vertical side parts 104 and 112 as the second section of the OTWS 100A and 1008 have a trim portion (base portion) 120 with a generally U-shaped cross section, which is adapted to be attached to the flange 16, and a tubular seal portion 122 formed integrally with the trim portion 120 to contact a protruding part of the door frame, thereby providing a seal between the vehicle door and the door opening portion 12.

The trim portion 120 has an outer side wall 124, an inner side wall 126 and a bottom wall 128 to define a generally U-shaped cross-section. An insert member 130 is embedded in the trim portion 120 for increasing its holding strength against the flange 16. The insert member 130 is made of a metallic plate or a hard resin, and in order to ensure the flexibility of the trim portion 120 upon attaching of the same to corners, it is configured like a ladder, a fish bone, a zigzag, etc. The trim portion 120 is composed of a solid material or a finely foamed material.

The tubular seal portion 122 is formed integrally with an exterior surface of the outer side wall 124. The tubular seal portion 122 is composed of a sponge material. When the vehicle door is closed, the tubular seal portion 122 contacts the door frame 14 to provide a seal between the vehicle door and the door opening portion 12. Joint parts between the tubular seal portion 122 and the outer side wall 124 are composed of a solid material so that when the tubular seal portion 122 contacts the door frame 14, abnormal deformation of the tubular seal portion 122 is prevented to effect sealing properties thereof. In addition, when the OTWS is curved in conformity with corners in the door opening portion 12, collapsing deformation of the tubular seal portion 122 can be prevented.

Outer holding lips 132 and an inner holding lip 134 adapted to hold the flange 16 are provided in the outer side wall 124 and the inner side wall 126 so as to extend in a longitudinal direction thereof, respectively. Tip ends of the outer holding lips 132 and the inner holding lip 134 contact both side faces of the flange 16 to securely hold the flange 16. Consequently, the trim portion 120 is prevented from being deflected downwardly, and the tubular seal portion 122 securely contacts the door frame 14, etc., thereby ensuring the sealing properties.

In the present embodiment, after extrusion, the outer holding lips 132 are three and short, and the inner holding lip 134 is single and long, and these holding lips project obliquely in an interior of the U-shaped trim portion 120, respectively. Consequently, the flange 16 is positioned on the inner side of the outer side wall 124, and is stably held with the three outer holding lips 132. The inner holding lip 134 presses the flange 16 against the outer side wall 124, thereby stably holding the flange 16. And, the outer and inner holding lips 132 and 134 securely flex in conformity with irregularities and deflections of the flange 16, and continuously contact the flange 16 to effect good sealing properties.

Since the inner holding lip 134 is made longer than the outer holding lips 132, as shown in FIG. 9, the inner holding lip 134 flexibly curves upon contacting the flange 16 in which the thickness varies, and consequently, the holing lips 132 and 134 can hold the flange 16 with good sealing properties.

A cover lip 136 may be provided on an exterior side of the bottom wall 128 of the trim portion 120 with an arc-shaped cross-section. The cover lip 136 thus arranged extends over a tip end of a garnish (not shown) mounted in the door opening portion 12 to cover a gap between the OTWS 100 and the garnish, thereby improving an appearance therearound.

Hereinafter, the lower side part 106 (110) of the present embodiment of the OTWS 100 as the first section thereof will be explained with reference to FIG. 10.

The trim portion 120 of the lower side 106 (110) has the outer side wall 124, the inner side wall 126 and the bottom wall 128, and is formed into a generally U-shaped cross-section, similarly to the cases of the upper side part 102 (114) and the vertical side part 104 (112). No insert member is embedded in the trim portion 120 so that the total weight of the OTWS 100 can be decreased, thereby decreasing the weight of the vehicle body. The trim portion 120 is composed of a solid material or a finely foamed material.

The tubular seal portion 122 is formed integrally with an exterior surface of the outer side wall 124. The tubular seal portion 122 is composed of a sponge material. When the vehicle door is closed, the tubular seal portion 122 contacts the door frame 14 to provide a seal between the door opening portion 12 and the door frame 14.

Outer holding lips 132 and the inner holding lip 134 are provided in the outer side wall 124 and the inner side wall 126 so as to extend in a longitudinal direction thereof, respectively. Tip ends of the outer holding lips 132 and the inner holding lip 134 contact both side faces of the flange 16 to securely hold the flange 16.

The trim portion 120 of the lower side part 106 (110) is covered with an inner cover 140. The inner cover 140 includes a cover part 142 for covering the trim portion 120, a main part 144 extending transversely from the cover part 142 and covering a lower side of the inner panel 18, and a leg part 146 extending downwardly from a rear surface of the main part 144.

A clip 148 is mounted on a lower side of the flange 16 of the door opening portion 12. The clip 148 has a flange holding part 150 with a U-shaped cross-section, which is adapted to be fitted on the flange 16, a cover holding part 152 defining a recess for holding the leg part 146 of the inner cover 140, and a connecting part 154 for connecting the flange holding part 150 to the cover holding part 152. The clip 148 extends longitudinally with a predetermined width, and is composed of a sheet metal.

In order to attach the lower side part 106 (110), first, the flange holding part 150 of the clip 148 is fitted on the flange 16, whereby the clip 148 is secured to the flange 16. Next, the trim portion 120 is mounted on the flange 16 on which the clip 148 is fitted. No insert member is embedded in the trim portion 120 so that the trim portion 120 can be elastically mounted on the flange 16, though the flange holding part 150 of the clip 148 is previously fitted thereon.

Next, the leg part 146 of the inner cover 140 is inserted in the cover holding part 152 of the clip 148. As a result, the clip 148 holds the leg part 146 so that the inner cover 140 can be held securely. Special works such as forming of holes in the flange 16, attaching of the inner cover 140 to the flange 16 with screws, etc. are not required. In addition, when a vehicle passenger gets on and off a vehicle, he does not contact the trim portion 120, because the cover part 142 of the inner cover 140 covers the trim portion 120, whereby the trim portion 120 can be protected.

With this arrangement, the inner cover 140 holds the trim portion 120 so that the trim portion 120 is prevented from coming off the flange 16. At this time, the tubular seal portion 122 protrudes outwardly of the cover part 142 of the inner cover 140 so that when the vehicle door is closed, the vehicle door contacts the tubular seal portion 122, thereby providing a seal therebetween.

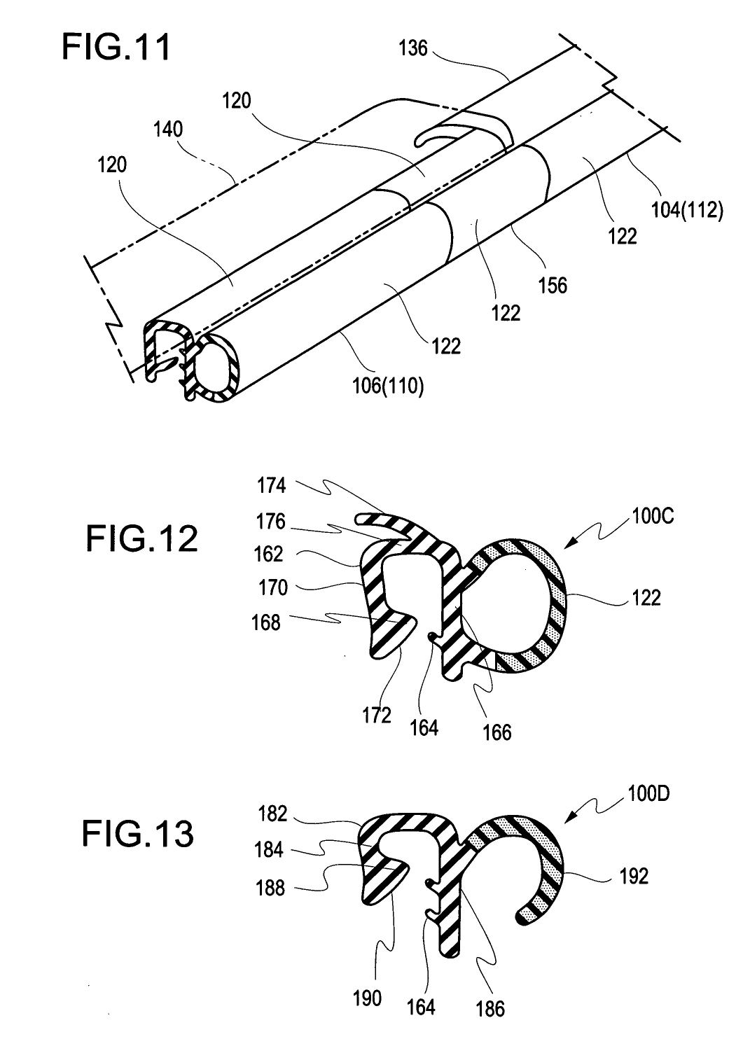

As shown in FIG. 11, the lower side part 106 (110) and the vertical side part 104 (112) as the first section and the second section are jointed to each other with a joint 156 by molding. The joint 156 has a trim portion and a tubular seal portion of which cross-sections gradually vary from those of the trim portion and the tubular seal portion of the vertical side part 104 (112) to those of the trim portion and the tubular seal portion of the lower side part 106 (110). The upper side part 102 (114) and the vertical side part 104 (112) respectively have the cover lip 136, whereas the joint 156 and the lower side part 106 (110) do not have such a cover lip.

Next, a second embodiment of an OTWS in accordance with the present invention will be explained with reference to FIG. 12.

The second embodiment is similar to the first embodiment except for the configuration of the trim portion of the lower side part of the OTWS as the first section thereof. Only the different points will be explained, and explanations of similar points will be omitted.

In an OTWS 100C of the second embodiment, a trim portion 162 of the lower side part 106 (110) is formed to have a generally U-shaped cross-section, and an outer holding lip 164 is provided in an interior surface of an outer side wall 166, whereas a thick-walled inner holding part 168 having a generally triangular cross-section is provided in an interior surface of an inner side wall 170. And a lower surface of the inner holding part 168 defines a guide slope 172.

Upon mounting the trim portion 162 on the flange 16, a tip end of the flange 16 slides on the guide slope 172 provided in the lower side of the inner holding part 168 to facilitate the insertion of the flange 16 in an interior of the trim portion 162. After insertion, the inner holding part 168 and the outer holding lip 164 can readily hold the flange 16.

In addition, a push lip 174 is provided in an exterior surface of a bottom wall 176 of the trim portion 162 so as to project obliquely upwardly. With this arrangement, when the cover part 142 of the inner cover 140 (FIG. 10) covers the trim portion 162, the push lip 174 contacts a lower surface of the cover part 142, whereby the cover part 142 pushes the push lip 174, and consequently, the trim portion 162 is pressed against the flange 16 to securely hold the same.

Next, a third embodiment of an OTWS in accordance with the present invention will be explained with reference to FIG. 13.

The third embodiment is similar to the first embodiment except for the configuration of the trim portion and the seal portion of the lower side part of the OTWS as the first section thereof. Only the different points will be explained and explanations of similar points will be omitted.

In an OTWS 100D of the third embodiment, a trim portion 182 of the lower side part 106 (110) is formed to have an inner side wall 184 that is shorter than an outer side wall 186. With this arrangement, upon mounting the trim portion 182 on the flange 16, the flange 16 on which the clip 148 (FIG. 10) is fitted can be readily inserted in the trim portion 182. In addition, the weight of the inner side wall 184 is reduced, thereby contributing to the reduction in weight of the vehicle body, and, similarly to the preceding embodiment, the trim portion 182 is covered with the inner cover 140 (FIG. 11), the trim portion 182 can be prevented from coming off the flange 16.

A thick-walled inner holding part 188 having a generally triangular cross-section is provided in an interior surface of the inner side wall 184, similarly to the second embodiment. And a lower surface of the inner holding part 188 defines a guide slope 190.

A seal lip 192 having a downwardly curving lip-shaped cross-section is provided. With this arrangement, the seal lip 192 readily bends, and when the vehicle door is closed, the seal lip 192 readily bends to lower a door closing force.

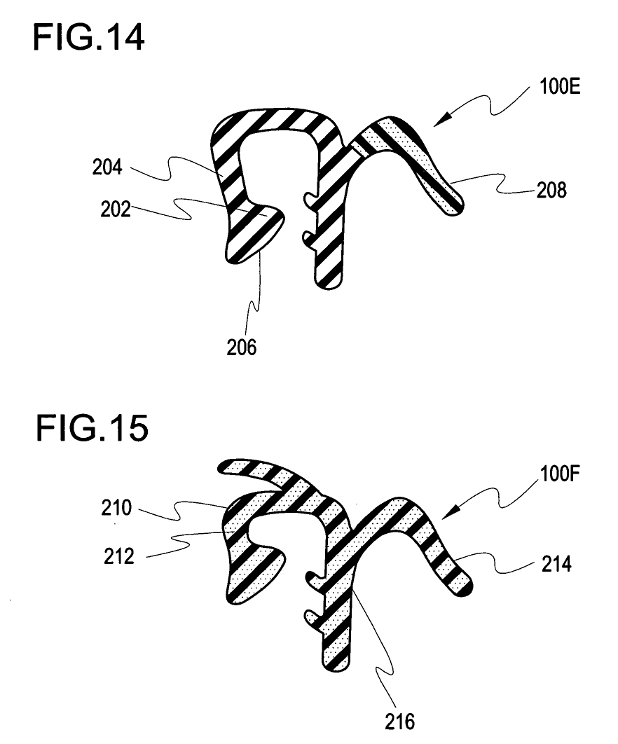

Next, a fourth embodiment of an OTWS in accordance with the present invention will be explained with reference to FIG. 14.

The fourth embodiment is similar to the first embodiment except for the configuration of the trim portion and the seal portion of the lower side part of the OTWS as the first section thereof. Only the different points will be explained, and explanations of similar points will be omitted.

In an OTWS 100E of the fourth embodiment, a thick-walled inner holding part 202 having a generally triangular cross-section is provided in an interior surface of an inner side wall 204 of the lower side part 106 as the first section, similarly to the second embodiment. And a lower surface of the inner holding part 202 defines a guide slope 206.

A seal lip 208 having a saddle-shaped cross-section is provided. A tip end of the seal lip 208 extends downwardly. With this arrangement, the seal lip 208 readily bends, and when the vehicle door is closed, the seal lip 208 readily bends along a ridge thereof to lower a door closing force.

Next, a fifth embodiment of an OTWS in accordance with the present invention will be explained with reference to FIG. 15.

The fifth embodiment is similar to the first embodiment except for the configuration of the trim portion and the seal portion of the lower side part of the OTWS as the first section thereof. Only the different points will be explained, and explanations of similar points will be omitted.

In an OTWS 100F of the fifth embodiment, a trim portion 210 and a seal lip 214 thereof are composed of a sponge material. With this arrangement, the OTWS 100F can be made light, whereby the vehicle body can be made light.

In addition, an inner side wall 212 of the trim portion 210 in the lower side part 106 (110) is made shorter than the outer side wall 216, similarly to the third embodiment, so that the vehicle body can be made light furthermore.

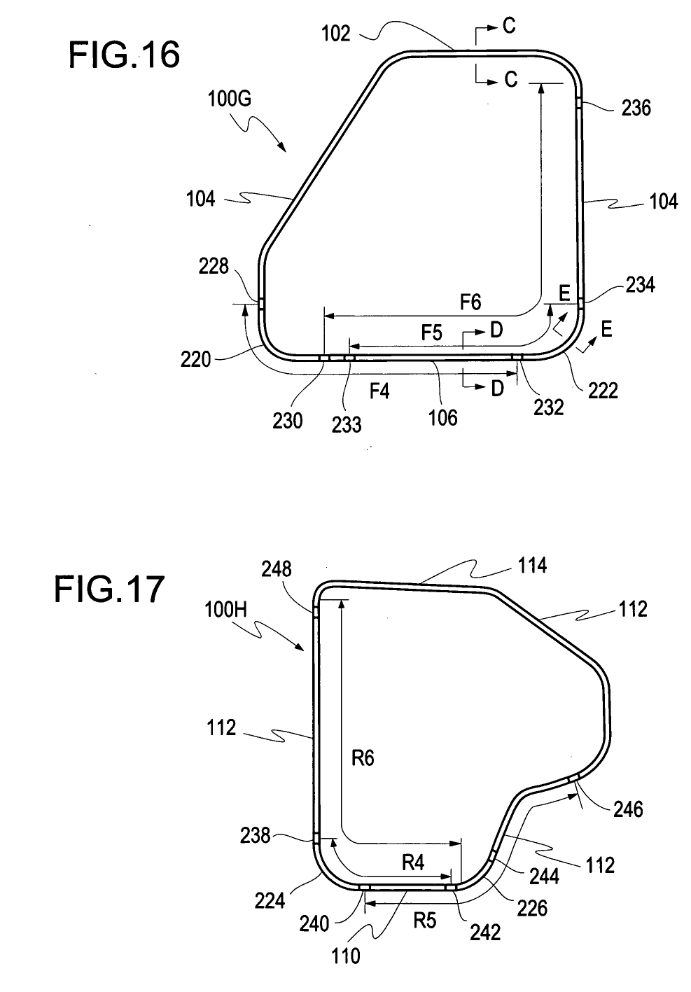

Next, a sixth embodiment of an OTWS in accordance with the present invention will be explained with reference to FIGS. 16 through 19.

FIG. 16 shows areas of the first section of an OTWS 100G for attachment to a front door of a motor vehicle.

An area designated as F4 corresponds to the case where the first section is formed in the lower side part 106 and a front corner 220, an area designated as F5 corresponds to the case where the first section is formed in the lower side part 106 and a rear corner 222, and an area designated as F6 corresponds to the case where the first section is formed in the lower side part 106, the rear corner 222 and a rear vertical side part 104 over the entire length thereof. In each of these cases, a remaining area of the OTWS 100G corresponds to the second section.

FIG. 17 shows areas of the first section of an OTWS 100H for attachment to a rear door of a motor vehicle.

An area designated as R4 corresponds to the case where the first section is formed in the lower side part 100 and a front corner 224, an area designated as R5 corresponds to the case where the first section is formed in the lower side part 110, the front corner 224 and a lower portion of a rear vertical side part 112, and an area designated as R6 corresponds to the case where the first section is formed in the lower side part 110, the front corner 224 and a front vertical side part 112 over the generally entire length thereof. In each of these cases, a remaining area of the OTWS 1001 corresponds to the second section, similarly to the case of the front door.

The present embodiment will be explained with reference to the case where the first section is formed in the lower side part 106 and the front corner 220 (F4), whereas the second section is formed in the upper side part 102, the front and rear vertical side parts 104 and the rear corner 222. The lower side part 106 is formed straight by extrusion using only a rubber-like elastic material without using any insert member. The upper side part 102, the front and rear vertical side parts 104 and the rear corner 222 in the second section are formed into a single straight piece by extrusion while embedding an insert member in a trim portion thereof, and is attached along the door opening portion 12 while partially bending the same.

Then, a joint 228 between the front vertical side part 104 and the front corner 220, a joint 230 between the front corner 220 and the lower side 106, a joint 232 between the lower side part 106 and the rear corner 222 are provided by molding. In this case, the rear corner 222 is provided continuously with the rear vertical side part 104. Consequently, the first section is connected to the second section via the joint 232 on the rear side of a vehicle body.

As a result, the first section includes a part wherein an insert member is embedded, and a remaining part wherein no insert member is embedded. The part wherein the insert member is embedded and the remaining part wherein no insert member is embedded are formed by extrusion, these parts are connected via the joints by molding, a loop-shaped body is provided. With this arrangement, the loop-shaped body can be readily attached to the flange 16 of the door opening portion 12 over an entire length thereof. The front corner 220 may be provided by forming the same continuously with the front vertical side part 104 by extrusion, and cutting away a cover lip. In this case, the joint 228 is not required to be provided. A front end of the first section that is covered with the inner cover 140 is located in this joint 228.

In the case of F5, the first section corresponds to the lower side part 106 and the rear corner 222. And the second section corresponds to the upper side part 102, the front and rear vertical side parts 104, and the front corner 220. No insert member is embedded in the lower side part 106 so as to be readily formed straight by extrusion, whereas the front and rear vertical side parts 104 and the front corner 220, respectively, have an insert member, and are formed straight by extrusion, similarly to the rear corner 222 as the first section. Then, they are connected to one another via the joints 233, 232 and 234 by molding, similarly to the case of F4. The rear corner 222 may be provided by extruding continuously with the rear vertical side part 104, and cutting away the cover lip therefrom, similarly to the case of F4. In this case, the joint 234 is not required to be provided.

In the case of F6, the first section corresponds to the lower side part 106, the rear corner 222, and the rear vertical side part 104 over a generally entire length thereof. And the second section corresponds to the upper side part 102, the front vertical side part 104, and the front corner 220. No insert member is embedded in the lower side part 106 and the rear vertical side part 104 so that they are readily formed straight by extrusion, whereas the front vertical side part 104, the front corner 220 and the rear corner 222, respectively, have an insert member, and are formed straight by extrusion. Then, they are connected to one another via the joints 230, 232, 234 and 236 by molding, similarly to the case of F4 and F5.

In a rear door of the present embodiment, as shown in FIG. 17, where the position of the first section is R4, the first section is provided in the lower side part 110 and the front corner 224. And the second section corresponds to the upper side part 114, the front and rear vertical side parts 112 and the rear corner 226. No insert member is embedded in the trim portion of the lower side part 110 so as to be readily formed straight by extrusion, similarly to the case of F4. The upper side part 114, the front and rear vertical side parts 112 and the rear corner 226 as the second section, respectively, have an insert member in the trim portion thereof, and are formed straight by extrusion. Then, they are attached along the door opening portion 12 while being locally bended.

And, as illustrated in FIG. 17, the front vertical side part 112 and the front corner 224 are connected by molding via a joint 238, the front corner 224 and the lower side part 110 are connected by molding via a joint 240, and the lower side part 110 and the rear corner 226 are connected by molding via a joint 242. The front corner 224 may be provided continuously with the front vertical side part 112 by extrusion, and only the cover lip may be cut away, similarly to the above-described case of F4. In this case, the joint 238 is not required to be provided.

In the case of R5, the first section corresponds to the lower side part 110, the rear corner 226, and a lower half of the rear vertical side part 112. And the second section corresponds to the upper side part 114, the front vertical side part 112, an upper half of the rear vertical side part 112 and the front corner 224. No insert member is embedded in the lower side part 110 so as to be readily formed straight by extrusion, whereas the front and rear vertical side parts 112, and the front corner 226, respectively, have an insert member, and are formed straight by extrusion, similarly to the case of R4. Then, they are connected to one another via the joints 240, 242 and 246 by molding, similarly to the case of R4. Alternatively, the rear corner 226 and the lower half of the rear vertical side part 112 may be formed by a single extruded body without providing a joint 244 therebetween.

In the case of R6, the first section corresponds to the lower side part 110, the front corner 224, and the front vertical side part 112. And the second section corresponds to the upper side part 114, the rear vertical side part 112, and the rear corner 226. No insert member is embedded in the lower side part 110 and the front vertical side part 112, whereas the rear vertical side part 112, and the rear corner 226, respectively, have an insert member, and are formed straight by extrusion. Then, they are connected to one another via the joints 238, 240, 242, and 248 by molding, similarly to the cases of R4 and F5.

The cases where the first section corresponds to F4 and R4 will be explained. Explanations of the other cases wherein the first section corresponds to F5, F6, R5, R6 are similar thereto.

In order to attach the OTWS 100G and 100H to the flange 16 of the vehicle body, the corners 220, 222, 224 and 226 or molded parts or the vicinity thereof are first attached to the flange 16, and then, the remaining parts are sequentially attached to the flange 16 based thereon.

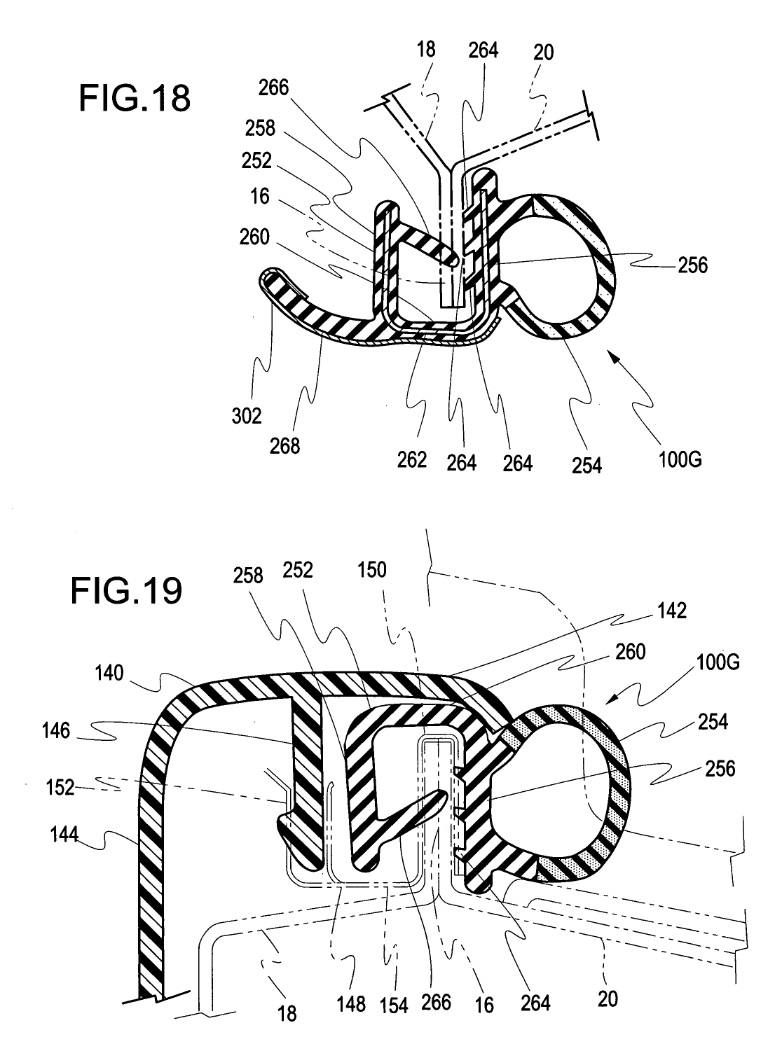

As shown in FIG. 18, the upper side part 102 and the vertical side part 104 as the second section of the OTWS 100H has a trim portion (base portion) 252 with a generally U-shaped cross section, which is adapted to be attached to the flange 16, and a tubular seal portion 254 formed integrally with the trim portion 252 to contact a protruding part of the door frame, thereby providing a seal between the vehicle door and the door opening portion 12, similarly to conventional examples of the OTWS. The tubular seal portion 254 is integrally provided in an exterior surface of an outer side wall 256

The trim portion 252 has the outer side wall 256, an inner side wall 258 and a bottom wall 260 to define a generally U-shaped cross-section. An insert member 262 is embedded in the trim portion 252 for increasing its holding strength against the flange 16. The insert member 262 is made of a metallic plate or a hard resin, and in order to ensure the flexibility of the trim portion 252 upon attaching of the same to corners, it is configured like a ladder, a fish bone, a zigzag, etc. The trim portion 252 is formed by covering the insert member 262 with a solid material or a finely foamed material. A sponge material may be used as a covering material.

The tubular seal portion 254 is formed integrally with the exterior surface of the trim portion 252. The tubular seal portion 254 is composed of a sponge material. When the vehicle door is closed, the tubular seal portion 254 contacts the door frame 14 to provide a seal between the vehicle door and the door opening portion 12. Joint parts of the tubular seal portion 254 to the outer side wall 256 is composed of a solid material so that when the tubular seal portion 254 contacts the door frame 14, abnormal deformation of the tubular seal portion 254 is prevented to effect sealing properties thereof. In addition, when the OTWS 100G is curved in conformity with corners in the door opening portion 12, collapsing deformation of the tubular seal portion 254 can be prevented.

Outer holding lips 264 and an inner holding lip 266 adapted to hold the flange 16 are provided in interior surfaces of the outer side wall 256 and the inner side wall 258 so as to extend in a longitudinal direction thereof, respectively. Tip ends of the outer holding lips 264 and the inner holding lip 266 contact both side faces of the flange 16 to securely hold the flange 16. Consequently, the trim portion 252 is prevented from being deflected downwardly, and the tubular seal portion 254 securely contacts the door frame 14, etc., thereby ensuring the sealing properties.

In the present embodiment, the outer holding lips 264 are three and short, and the inner holding lip 266 is single and long, and these holding lips project obliquely in an interior of the U-shaped trim portion 252, respectively. Consequently, the flange 16 is positioned on the inner side of the outer side wall 256, and is stably held with the three outer holding lips 264. The inner holding lip 266 presses the flange 16 against the outer side wall 256, thereby stably holding the flange 16. And, the outer and inner holding lips 264 and 266 securely flex in conformity with irregularities and deflections of the flange 16, and continuously contact the flange 16 to effect good sealing properties.

Since the inner holding lip 266 is made longer than the outer holding lips 264, the inner holding lip 266 flexibly curves upon contacting the flange 16 of which the thickness varies, and consequently, the holing lips 264 and 266 can hold the flange 16 with good sealing properties.

A cover lip 268 is provided on an exterior side of the bottom wall 260 of the trim portion 252 with an arc-shaped cross-section. The cover lip 268 thus arranged covers a tip end of a garnish (not shown) mounted in the door opening portion 12 to cover a gap between the OTWS 100G and the garnish, thereby improving an appearance therearound.

Between the first section and the second section, namely, between the rear corner 222 and the lower side part 106, the joint 232 is provided. The joint 232 has a trim portion and a tubular seal portion of which cross-sections vary from the side of the rear corner 222 to the side of the lower side part 106.

In the vicinity of the joint 232, the second section has the cover lip 268, whereas the first section does not have such a cover lip. The front corner 220 and the lower side part 106 are similarly connected by molding. In this case, no cover lip is provided therein.

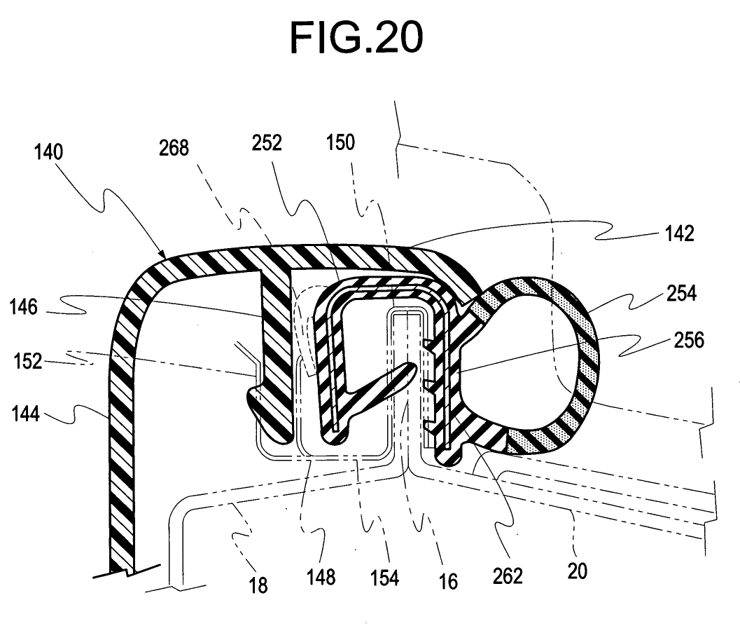

The lower side part 106 and the front corner 220, as the first section of the OTWS 100G, will be explained with reference to FIGS. 19 and 20.

The trim portion 252 of the lower side part 106 has the outer side wall 256, the inner side wall 258 and the bottom wall 260, and is formed into a generally U-shaped cross-section, similarly to the upper side part 102 and the vertical side part 104. No insert member is embedded in the trim portion 252 so that the total weight of the OTWS 100G can be decreased, thereby decreasing the weight of the vehicle body.

The tubular seal portion 254 is formed integrally with an exterior surface of the outer side wall 256. The tubular seal portion 254 is composed of a sponge material. When the vehicle door is closed, the tubular seal portion 254 contacts the door frame 14 to provide a seal between the door opening portion 12 and the door frame 14.

Outer holding lips 264 and the inner holding lip 266 are provided in interior surfaces of the outer side wall 156 and the inner side wall 258 so as to extend in a longitudinal direction thereof, respectively, similarly to the second section. Tip ends of the outer holding lips 264 and the inner holding lip 266 contact both side faces of the flange 16 to securely hold the flange 16.

The trim portion 252 of the lower side part 106 is covered with an inner cover 140. The inner cover 140 includes a cover part 142 for covering the trim portion 252, a main part 144 extending transversely from the cover part 142 and covering the lower side of the inner panel 18, and a leg part 146 extending downwardly from a rear surface of the main part 144. The trim portion 252 of the first section has no cover lip. Where the trim portion 252 of the front corner 220 is extruded continuously with the second section, the cover lip 268 of the second section is cut away, and where the trim portion 252 in which the insert member is embedded is extruded, the extrusion is carried out without providing any cover lip.

A clip 148 is mounted on a lower side of the flange 16 of the door opening portion 12. The clip 148 has a flange holding part 150 with a U-shaped cross-section, which is adapted to be fitted on the flange 16, a cover holding part 152 defining a recess for holding the leg part 146 of the inner cover 140, and a connecting part 154 for connecting the flange holding part 150 to the cover holding part 156. The clip 148 extends longitudinally with a predetermined width, and is composed of a sheet metal.

In order to attach the lower side part 106, first, the flange holding part 150 of the clip 148 is fitted on the flange 16, whereby the clip 148 is secured to the flange 16. Next, the trim portion 252 is mounted on the flange 16 on which the clip 148 is fitted. No insert member is embedded in the trim portion 252 so that the trim portion 252 can be elastically mounted on the flange 16, though the flange holding part 150 of the clip 148 is fitted thereon.

Next, the leg part 146 of the inner cover 140 is inserted in the cover holding part 152 of the clip 148. As a result, the clip 148 holds the leg part 146 so that the inner cover 140 can be held securely. Special works such as forming of holes in the flange 16, attaching of the inner cover 140 to the flange 16 with screws, etc. are not required. In addition, when a vehicle passenger gets on and off a vehicle, he does not directly contact the trim portion 252 of the first section, because the cover part 142 of the inner cover 140 covers the trim portion 252, whereby the trim portion 252 can be protected.

The trim portion 252 of the OTWS 100G of the first section can be composed of a solid material, but is preferably composed of a sponge material. In this case, the weight of the OTWS 100G can be further reduced, and consequently, the weight of the vehicle body is further reduced. Since the trim portion 252 of the first section is covered with the inner cover 140, the trim portion 252 is prevented from coming off the flange 16 though the trim portion 252 is composed of a sponge material and no insert member is embedded therein.

Since the tubular seal portion 254 protrudes outwardly of the cover part 142 of the inner cover 140 so that when the vehicle door is closed, the vehicle door contacts the tubular seal portion 254, thereby providing a seal therebetween.

Next, the front corner 220 will be explained with reference to FIG. 20. The trim portion 252 of the front corner 220 has the outer side wall 256, the inner side wall 258 and the bottom wall 260, similarly to the lower side part 106, and is formed into a generally U-shaped cross-section. The insert member 262 is embedded in the trim portion 252 so that the first section and the second section, which have the insert member 262, can exhibit a strong holding force against the flange 16. Where the front corner 220 is curved, and is attached to the flange 16 curving along a corner of the door opening portion 12, the trim portion 252 can hold the flange 16 securely without coming off the flange 16.

The trim portion 252 of the front corner 220 of the first section extends from the trim portion 252 of the second section, and can be composed of a rubber-like elastic body from which a cover lip is cut away and in which the insert member 262 is embedded. In this case, the trim portion 252 of the front corner 220 of the first section and the trim portion 252 of the second section are continuously formed by extrusion. No molded joint is required to be provided. By merely cutting away the cover lip 268, the OTWS100G can be readily formed.

The tubular seal portion 254 is formed integrally with an exterior surface of the outer side wall 256. The tubular seal portion 254 is composed of a sponge material. When the vehicle door is closed, the tubular seal portion 254 contacts the door frame 14 to provide a seal between the door opening portion 12 and the door frame 14.

Outer holding lips 264 and the inner holding lip 266 are provided in interior surfaces of the outer side wall 156 and the inner side wall 258 so as to extend in a longitudinal direction thereof, respectively. Tip ends of the outer holding lips 264 and the inner holding lip 266 contact both side faces of the flange 16 to securely hold the flange 16.

In the front corner 220 of the first section, the insert member 262 is embedded in the trim portion 252 so that where the trim portion 252 is curved along a corner of the flange 16, the configuration thereof can be held. Where the trim portion 252 comes off the flange 16 at an end of the inner cover 140, because no clip is provided therein, the end of the inner cover 140 readily deforms in the direction away from the flange 16. In the present embodiment, the holding force of the trim portion 252 is enhanced by virtue of the insert member 262 to prevent the trim portion 252 from coming off the flange 16, thereby preventing the deformation of the end of the inner cover 140.

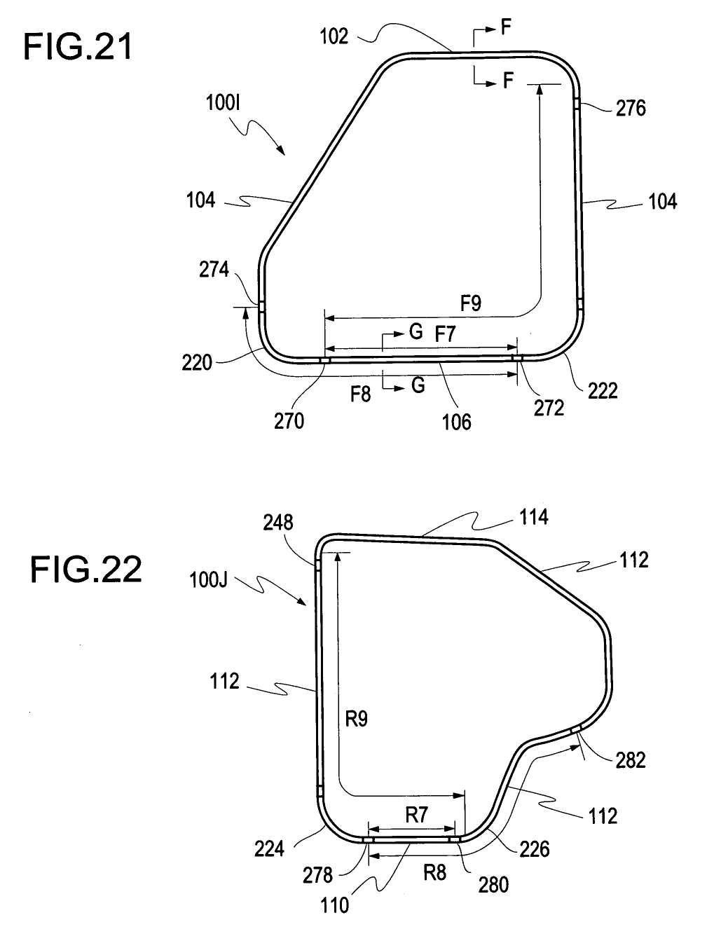

FIGS. 21 through 24 show a seventh embodiment of an OTWS of the present invention.

FIG. 21 shows areas of the first section of an OTWS 100I for attachment to a front door of a motor vehicle.

An area designated as F7 corresponds to the case where the first section is formed in the lower side part 106, an area designated as F8 corresponds to the case where the first section is formed in the lower side part 106 and the front corner 220, and an area designated as F9 corresponds to the case where the first section is formed in the lower side part 106, the rear corner 222 and the rear vertical side part 104 over the entire length thereof. In each of these cases, a remaining area of the OTWS 1001 corresponds to the second section.

FIG. 22 shows areas of the first section of an OTWS 100J for attachment to a rear door of a motor vehicle.

An area designated as R7 corresponds to the case where the first section is formed in the lower side part 110, an area designated as R8 corresponds to the case where the first section is formed in the lower side part 110, the rear corner 226 and a lower portion of the rear side vertical side 112, and an area designated as R9 corresponds to the case where the first section is formed in the lower side part 110, the front corner 224 and a front vertical side part 112 over the entire length thereof. In each of these cases, a remaining area of the OTWS 100J corresponds to the second section, similarly to the case of the front door.

In the present embodiment, in both the first section and the second section, an insert member is embedded in a trim portion (base portion) with a generally U-shaped cross section, but the cross-sectional shape thereof differs between the first section and the second section such that the cross-sectional area of the first section is smaller than that of the second section. Each of the first section and the second section is formed straight by extrusion such that an insert member is embedded in a trim portion thereof, and is attached along the door opening portion while being locally bended.

And, as shown in FIG. 21, where the trim portion of the present embodiment is attached to the area F7, the first section and the second section are connected to each other via a joint 270 between the front corner 220 and the lower side part 106, and a joint 272 between the rear corner 222 and the lower side part 106, respectively, by molding.

In the case of the area F8, the first section and the second section are connected to each other via a joint 274 between the front vertical side part 104 and the front corner 220, and the joint 272 between the lower side part 106 and the rear corner 222, respectively, by molding.

In the case of the area F9, the first section and the second section are connected to each other via the joint 270 between the lower side part 106 and the front corner 220, and a joint 276 between the rear vertical side part 104 and the upper side part 102, respectively, by molding.

In a rear door of the present embodiment. as shown in FIG. 22, where the trim portion of the present embodiment is attached to the area R7, an insert member is embedded in each of the first section and the second section, similarly the case of the area F7, but the cross-sectional shape of the trim portion differs between the first section and the second section such that the cross sectional area of the trim portion of the first section is smaller than that of the second section. Each of the first section and the second section is formed straight by extrusion.

And the first section and the second section are connected to each other via a joint 278 between the front corner 224 and the lower side part 110, and a joint 280 between the rear corner 226 and the lower side part 110, respectively, by molding.

In the case of the area R8, the first section and the second section are connected to each other via the 278 between the front corner 224 and the lower side part 110, similarly to the case of R7, and a joint 282 between a lower half of the rear vertical side part 112 inclusive of the rear corner 226, and an upper half of the rear vertical side part 112, respectively, by molding.

And in the case of the area R9, the first section and the second section are connected to each other via the joint 280 between the rear corner 226 and the lower side part 110, similarly to the case of R7, and a joint 284 between the upper side part 114 and the front vertical side part 112, respectively, by molding.

The cases wherein the first section is lower side part 110 (F7 and R7) will be explained. Explanations of the other cases wherein the first section corresponds to F8, F9, R8, R9 are similar thereto.

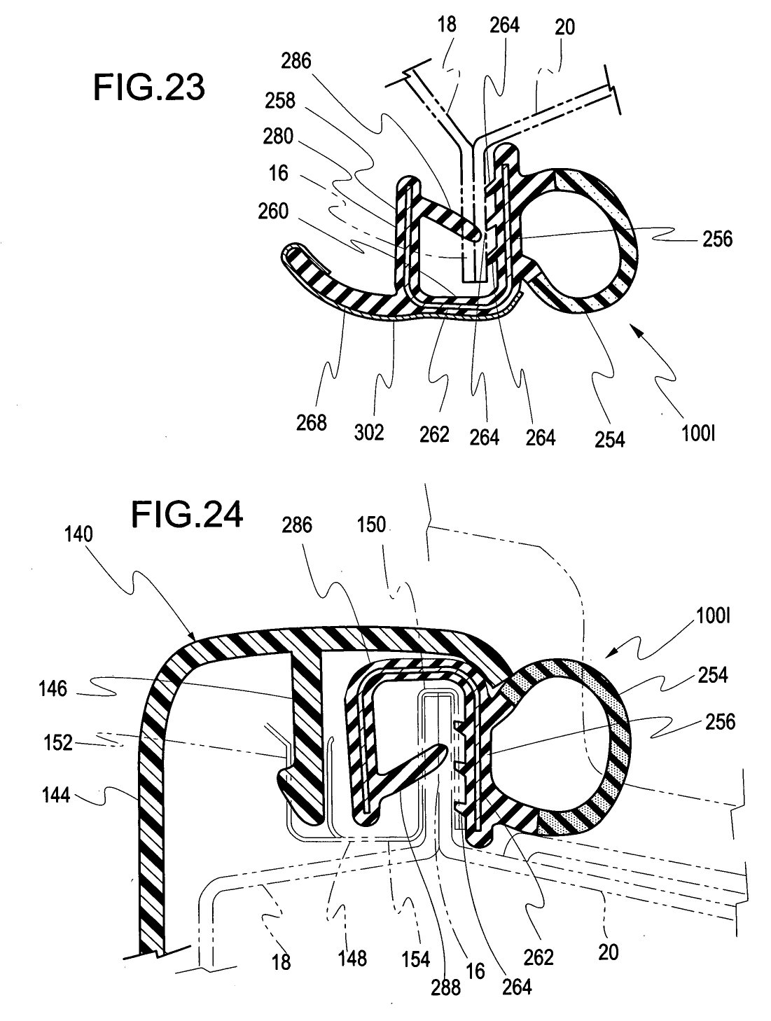

Constructions of the OTWS 1001 and 100J are similar to those shown in FIG. 18 and FIG. 20 (the sixth embodiment). Only different points will be explained. In FIGS. 23 and 24, parts similar to those in FIGS. 18 and 20 are given the same number as in FIGS. 18 and 20.

As shown in FIG. 24, the cross-sectional area of a trim portion 286 of the first section is smaller than that of the second section. Namely, an inner holding lip 288 of the first section is formed shorter than that of the second section. Therefore, the weight of the trim portion 286 can be decreased, thereby reducing the entire weight of the OTWS 1001. Since an insert member is embedded in the trim portion 286 of the first section, and the trim portion 286 is covered with the inner cover 140, the holding force of the inner holding lip 288 can be ensured, though it is formed short.

Where the trim portion 286 of the first section is extruded continuously with that of the second section, in the first section, the cover lip is cut away and the inner holding lip is cut to a smaller length. Where the trim portion 286 of the first section is extruded separately from that of the second section, the trim portion 286 of the first section is extruded such that the inner holding lip 288 is short and no cover lip is provided.

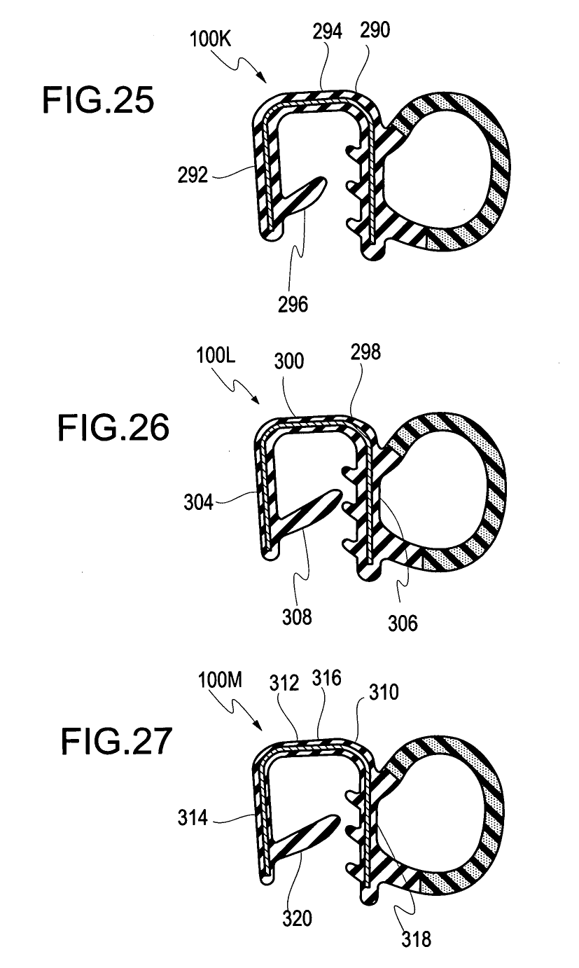

A trim portion 290 in a first section of an OTWS 100K in an eighth embodiment of the present invention will be explained with reference to FIG. 25.

The trim portion 290 of the present embodiment differs from that of the seventh embodiment in dimensions of an inner side wall 292. The remaining arrangement is identical to that of the seventh embodiment. Only different points will be explained, and explanations of similar points will be omitted.

In the present embodiment, the inner side wall 292 of the trim portion 290 in the first section is formed so as to have a height less than that in the second section. Namely, a projecting part from a bottom wall 294 is formed short. With this arrangement, the weight of the trim portion 290 in the first section can be reduced, thereby contributing to the reduction in weight of a vehicle body. In addition, in this case, an inner holding lip 296 may be formed short, too, similarly to the seventh embodiment.

Next, a trim portion 298 in a first section of an OTWS 100L in a ninth embodiment of the present invention will be explained with reference to FIG. 26.

The trim portion 298 of the present embodiment differs from that of the seventh embodiment in that the wall thickness thereof on an exterior side of an insert member 300 is smaller than that in the second section. The remaining arrangement is identical to that of the seventh embodiment. Only different points will be explained, and explanations of similar points will be omitted.

In the present embodiment, an exterior surface of the trim portion in the second section has a decorative layer, whereas an exterior surface of the trim portion 298 in the first section has no decorative layer. Therefore, the wall thickness of the trim portion 298 in the first section can be decreased by the thickness of the decorative layer, whereby the weight of the trim portion 298 can be decreased, thereby contributing to the reduction in weight of a vehicle body. In addition, the wall thickness of an inner side wall 304 and an outer side wall 306 of the trim portion 298 on an exterior side of the insert member 300 can be decreased, too. Since the insert member 300 is embedded in the trim portion 298, the holding force against the flange 16 can be ensured. In addition, in the present embodiment, an inner holding lip 308 and/or the inner side wall 304 may be formed short, similarly to the seventh and eighth embodiments.

A trim portion 310 in a first section of an OTWS 100M in a tenth embodiment of the present invention will be explained with reference to FIG. 27.

The trim portion 310 of the present embodiment differs from that of the seventh embodiment in that the wall thickness thereof on an interior side of an insert member 312 is smaller than that in the second section. The remaining arrangement is identical to that of the seventh embodiment. Only different points will be explained, and explanations of similar points will be omitted.

In the present embodiment, the wall thickness of the trim portion 310 on an interior side of the insert member 312 is made smaller, as compared with the interior side of the insert member in the second section. Therefore, the weight of the trim portion 310 can be decreased, thereby contributing to the reduction in weight of a vehicle body. In addition, the wall thickness of an inner side wall 314, a bottom wall 316 and an outer side wall 318 of the trim portion 310 can be decreased on an exterior side of the insert member 312, too. Since the insert member 312 is embedded in the trim portion 310, the holding force against the flange 16 can be ensured. In addition, in the present embodiment, an inner holding lip 320 and/or the inner side wall 314 may be formed short, similarly to the seventh and eighth embodiments.

In order to decrease the weight of an OTWS, It is preferable to adopt all arrangements of the seventh through tenth embodiments. In addition, since no cover lip is provided in the first section, the weight of the OTWS can be further decreased. And the seventh through tenth embodiments have been explained with reference to the case where the first section is F7, but these embodiments can be applied to the cases where the first section is F8, F9, R7, R8 and R9.

In the OTWS in accordance with the present invention, where the tubular seal portion or the seal lip is composed of a sponge material of an EPDM rubber or a thermoplastic olefin elastomer, and the trim portion is composed of a solid material or a finely foamed material of an EPDM rubber or a thermoplastic olefin elastomer, products with good weather resistance can be obtained. In addition, in this case, the OTWS is entirely composed of olefin materials so that they can be recycled after pulverized together.

The present invention can be applied to an OTWS in which the first section and the second section are connected to each other in the vicinity of a door belt line.

Next, the producing method of the OTWS in accordance with the present invention will be explained.

The second section of the OTWS is formed by extrusion, and a solid rubber composing the trim portion, and a sponge rubber composing the insert member and the tubular seal portion can be integrally extruded with an extruder. The first section of the OTWS is formed, similarly to the second section, except that no insert member is provided.

Then, vulcanization is carried out by a normal vulcanization method, the first section is cut to a predetermined length and the second section is cut to a predetermined length. Cut ends of the first section and the second section are held with a mold, and joints are formed by molding, whereby a loop-shaped OTWS is obtained.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. An opening trim weather strip for a motor vehicle, which is attached to a door opening portion of a motor vehicle for providing a seal between a door of the motor vehicle and the door opening portion, comprising:
a trim portion for attachment to a flange provided in the door opening portion; and
a seal portion integrally formed with said trim portion for contacting the door to provide a seal between the door and the door opening portion, wherein
said trim portion includes an upper side part, a vertical side part, and a lower side part for attachment to an upper side, a vertical side and a lower side of the door opening portion, respectively, and is formed into a loop-like configuration,
said door opening trim weather strip includes a first section in which one of said lower side part and said vertical side part along with said lower side part is partially covered with an inner cover, and a second section that is not covered with said inner cover, and
said trim portion in said first section and said trim portion in said second section are formed so as to have different cross-sectional constructions.

2. An opening trim weather strip as claimed in claim 1, wherein said trim portion includes an outer side wall, an inner side wall and a bottom wall, and has a generally U-shaped cross-section, said trim portion in said first section is entirely composed of a rubber-like elastic body, and said trim portion in said second section is composed of a rubber-like elastic body in which an insert member is embedded such that said rubber-like elastic bodies in said first section and said second section have different cross-sectional constructions.

3. An opening trim weather strip as claimed in claim 1, wherein an insert member is embedded in said first section and said second section, and said trim portion in said first section has a cross-sectional area less than that of said trim portion in said second section so as to have different cross-sectional constructions.

4. An opening trim weather strip as claimed in claim 1, further comprising a cover lip extending from said trim portion in said second section toward an interior of the motor vehicle.

5. An opening trim weather strip as claimed in claim 1, further comprising a front corner part and a rear corner part connected via said lower side part, wherein said first section covered with said inner cover includes said lower side part and at least one of said front corner part and said rear corner part, said trim portion in said first section is composed of a rubber-like elastic body such that an insert member is embedded in said corner part and no insert member is embedded in a remaining part.

6. An opening trim weather strip as claimed in claim 3, wherein said first section includes at least said lower side part, and said trim portion in said first section has a cross-sectional area less than that of said trim portion in said second section so as to have a cross-sectional construction different from that of said trim portion in said second section.

7. An opening trim weather strip as claimed in claim 3, wherein said trim portion in said first section has an inner side wall of which a widthwise length is formed shorter than that of an inner side wall in said second section.

8. An opening trim weather strip as claimed in claim 3, wherein said trim portion in said first section has a holding lip provided in an interior thereof so as to be formed shorter than a holding lip of in said second section.

9. An opening trim weather strip f as claimed in claim 3, further comprising a decorative layer provided on an exterior surface of said trim portion in said second section, wherein no decorative layer is provided on an exterior surface of said trim portion in said first section so as to decrease the cross-sectional area thereof.

10. An opening trim weather strip as claimed in claim 3, wherein side walls of said trim portion in said first section have a wall thickness less than that of side walls of said trim portion in said second section.

11. An opening trim weather strip as claimed in claim 3, wherein said trim portion in said first section is composed of a sponge material, and said trim portion in said second section is composed of a solid material.

12. An opening trim weather strip as claimed in claim 3, wherein said insert member is embedded in one part of said first section, and is not embedded in the other part of said first section, and said one part of said first section, in which said insert member is embedded, said the other part of said first section, in which said insert member is not embedded, and said second section are connected by molding.

13. An opening trim weather strip as claimed in claim 3, wherein said first section includes said lower side part and front and rear vertical side parts, said trim portion in corner parts between said lower side part and said front and rear vertical side parts is composed of a rubber-like elastic body in which said insert member is embedded, so as to have a cross-section smaller than that in said second section.

14. An opening trim weather strip as claimed in claim 13, wherein said trim portion in said first section is composed of a sponge material, said trim portion in said second section is composed of a solid material.

15. An opening trim weather strip as claimed in claim 1, wherein a clip is fitted on the flange of the door opening portion, which faces said first section, and said inner cover is secured with said clip.

16. An opening trim weather strip as claimed in claim 15, wherein said inner cover has a cover part for covering said trim portion and a leg part projecting from a rear surface of said cover part, and said leg part is secured with said clip fitted on the flange.

17. An opening trim weather strip as claimed in claim 1, wherein said seal portion has one of a tubular configuration and a lip-shaped configuration.

18. An opening trim weather strip as claimed in claim 1, further comprising a push lip provided in an exterior surface of a bottom wall of said trim portion in said first section so as to extend upwardly.
